(19) United States
(12) Patent Application Publication
(10) Pub. No.: US 2018/0251136 A1
(43) Pub. Date: Sep. 6, 2018

(54) ENHANCED LANE BEHAVIOR DETECTION

(71) Applicant: Ford Global Technologies, LLC, Dearborn, MI (US)

(72) Inventors: KWAKU O. PRAKAH-ASANTE, Commerce Township, MI (US); YIFAN CHEN, Ann Arbor, MI (US); BASAVARAJ TONSHAL, Northville, MI (US); PADMA AISWARYA KOLISETTY, Chennai (IN); HSIN-HSIANG YANG, Ann Arbor, MI (US)

(73) Assignee: Ford Global Technologies, LLC, Dearborn, MI (US)

(21) Appl. No.: 15/757,993

(22) PCT Filed: Oct. 20, 2015
(86) PCT No.: PCT/US2015/056340

§ 371 Date: Mar. 7, 2018

(51) Int. Cl. B60W 50/16; B60W 30/12; G06F 3/01; B60W 40/09; G06F 1/16

(52) U.S. Cl. CPC B60W 50/16; B60W 30/12; G06F 1/163; B60W 40/09; G06F 3/016

(57) ABSTRACT

A lane behavior detection value that is a measure of wrist movement of a vehicle occupant is determined. A mechanism in a wearable device is actuated when the lane behavior detection value exceeds a threshold.

### CROSS-REFERENCE TO RELATED APPLICATIONS

This application is a national stage of, and claims priority to, Patent Cooperation Treaty Application No. PCT/US2015/056340, filed on Oct. 20, 2015, which application is hereby incorporated herein by reference in its entirety.

### BACKGROUND

Lane Behavior Warning (LBW) systems provide a way for vehicle drivers to adjust their driving behavior if their lane behavior is erratic. Such systems may indicate erratic lane driving behavior so that a vehicle driver can take corrective action. However, not all vehicles include LBW systems, and thus have no way to indicate erratic lane behavior.

### BRIEF DESCRIPTION OF THE DRAWINGS

FIG. 1 is a block diagram of an example system including a wearable device providing output indicating lane behavior.

FIG. 2 is a block diagram of an example process for providing an indication of lane behavior.

### DETAILED DESCRIPTION

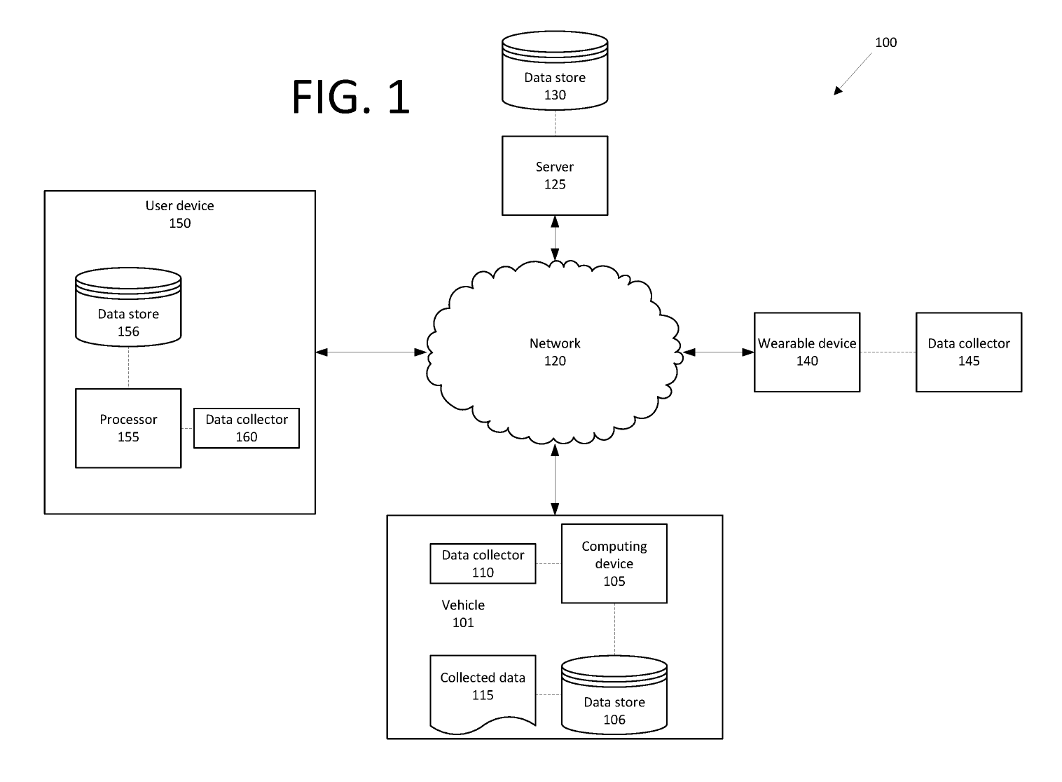

FIG. 1 illustrates a system 100 including a wearable device 140 communicatively coupled to a vehicle 101 computing device 105. The computing device 105 is programmed to receive collected data 115 from one or more data collectors 110, e.g., vehicle 101 sensors, concerning various metrics related to the vehicle 101. For example, the metrics may include a velocity of the vehicle 101, vehicle 101 acceleration and/or deceleration, data related to vehicle 101 path or steering, biometric data related to a vehicle 101 operator, e.g., heart rate, respiration, pupil dilation, body temperature, state of consciousness, etc. Further examples of such metrics may include measurements of vehicle systems and components (e.g. a steering system, a powertrain system, a brake system, internal sensing, external sensing, etc.). The computing device 105 may be programmed to collect data 115 from the vehicle 101 in which it is installed, sometimes referred to as a host vehicle 101, and/or may be programmed to collect data 115 about a second vehicle 101, e.g., a target vehicle.

The computing device 105 is generally programmed for communications on a controller area network (CAN) bus or the like. The computing device 105 may also have a connection to an onboard diagnostics connector (OBD-II). Via the CAN bus, OBD-II, and/or other wired or wireless mechanisms, the computing device 105 may transmit messages to various devices in a vehicle and/or receive messages from the various devices, e.g., controllers, actuators, sensors, etc., including data collectors 110. Alternatively or additionally, in cases where the computing device 105 actually comprises multiple devices, the CAN bus or the like may be used for communications between devices represented as the computing device 105 in this disclosure. In addition, the computing device 105 may be programmed for communicating with the network 120, which, as described below, may include various wired and/or wireless networking technologies, e.g., cellular, Bluetooth, wired and/or wireless packet networks, etc.

The computing device 105 may be programmed to generate a lane departure warning. For example, the computing device 105 may receive collected data 115 relating to a vehicle 101 speed, acceleration, deceleration, steering angle, steering angle rate of change, braking, etc., and/or data 115 relating to a roadway, e.g., that the vehicle 101 is crossing land makers, is varying a lateral distance from lane markers, etc. Based on such collected data 115 and possibly also a lane departure profile of a vehicle 101 driver as discussed below, the computer 105 may, e.g., in a known manner, determine that a lane departure is imminent and/or that the vehicle 101 is at a risk of an unintended lane departure over a predetermined threshold, whereupon a lane departure warning may be generated. The computing device 105 may further store instructions to determine whether the vehicle 101 is about to leave a current land and, upon such determination, to actuate one or more vehicle mechanisms without driver intervention, e.g., braking, steering, throttle, etc. Further, the computing device 105 may include or be connected to an output mechanism to indicate a potential lane departure, e.g., sounds and/or visual indicators provided via the vehicle 101 HMI. The data store 106 may be of any known type, e.g., hard disk drives, solid-state drives, servers, or any volatile or non-volatile media. The data store 106 typically stores the collected data 115 sent from the data collectors 110.

Collected data 115 may include a variety of data collected in a vehicle 101. Examples of collected data 115 are provided above, and moreover, data 115 is generally collected using one or more data collectors 110, and may additionally include data calculated therefrom in the computer 105, and/or at the server 125. In general, collected data 115 may include any data that may be gathered by the data collectors 110 and/or computed from such data.

The system 100 may further include a network 120 connected to a server 125 and a data store 130. The computer 105 may further be programmed to communicate with one or more remote sites such as the server 125, via a network 120, such remote site possibly including a data store 130. The network 120 represents one or more mechanisms by which a vehicle computer 105 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be programmed to determine an appropriate action for one or more vehicles 101, and to provide direction to the computer 105 to proceed accordingly. The server 125 may be one or more computer servers, each generally including at least one processor and at least one memory, the memory storing instructions executable by the processor, including instructions for carrying out various steps and processes described herein. The server 125 may include or be communicatively coupled to a data store 130 for storing collected data 115, records relating to potential incidents generated as described herein, lane departure profiles, etc. Further, the server 125 may store information related to particular vehicle 101 and additionally one or more other vehicles 101 operating in a geographic area, traffic conditions, weather conditions, etc., within a geographic area, with respect to a particular road, city, etc. The server 125 could be programmed to provide alerts to a particular vehicle 101 and/or other vehicles 101.

A wearable device 140 may be any one of a variety of computing devices including a processor and a memory, as well as communication capabilities that is programmed to be worn on a driver's body. For example, the wearable device 140 may be a watch, a smart watch, a vibrating apparatus, etc. that includes capabilities for wireless communications using IEEE 802.11, Bluetooth, and/or cellular communications protocols. Further, the wearable device 140 may use such communications capabilities to communicate via the network 120 and also directly with a vehicle computer 105, e.g., using Bluetooth. The wearable device 140 may include at least one data collector 145. The data collector 145 may be a motion sensor, e.g., an accelerometer, a gyroscope, a global position sensor, or some other motion sensor. The device 140 may be programmed to, using measurements from the data collector 145, determine the wrist and/or arm movement of the a vehicle 101 occupant wearing the device 140 to, e.g., determine steering wheel movement of the vehicle 101, thereby providing data 115 to a user device 150 to determine lane behavior. The data collector 145 may also collect data on the position of the wearable device 140 lateral to the forward motion of the vehicle 101.

The system 100 may include a user device 150. The user device 150 may be any one of a variety of computing devices including a processor and a memory, e.g., a smartphone, a tablet, a personal digital assistant, etc. the user device 150 may use the network 120 to communicate with the vehicle computer 105 and the wearable device 140. The wearable device 140 may send data to the user device 150 for processing. The user device 150 generally includes a processor 155, a data store 156, and a plurality of data collectors 160. The data collectors 160 may include, e.g., a location sensor, a camera, an audio-video collector, etc.

The user device 150 may use the collected data 115 to develop a lane behavior profile for a vehicle 101 occupant. The lane behavior profile may incorporate the occupant's driving habits and characteristics, e.g., age, experience driving, etc., as well as the collected data 115, e.g. road condition, movement of the vehicle 101, etc. For example, more sensitive lane behavior warning thresholds may be established for a novice or less-experienced driver. The lane behavior profile may be used by the user device 150 to detect lane behavior, e.g., to generate a lane behavior warning for the vehicle 101 occupant. The user device 150 may create respective lane behavior profiles for respective vehicle 101 drivers, and may store the profiles in the data store 156.

Data collectors 110, 160 may include a variety of devices. For example, various controllers in a vehicle may operate as data collectors 110, 160 to provide data 115 via the CAN bus and/or the network 120, e.g., data 115 relating to vehicle speed, acceleration, system and/or component functionality, etc., of any number of vehicles 101. Further, sensors or the like, global positioning system (GPS) equipment, etc., could be included in a vehicle 101 and/or the user device 150 and configured as data collectors 110, 160 to provide data directly to the computer 105, e.g., via a wired or wireless connection. Sensor data collectors 110 could include mechanisms such as RADAR, LIDAR, sonar, etc. sensors that could be deployed to measure a distance between the vehicle 101 and other vehicles or objects. Yet other data collectors 110, 160 could include cameras, breathalyzers, motion detectors, etc., i.e., data collectors 110, 160 to provide data 115 for evaluating a condition or state of a vehicle 101 operator.

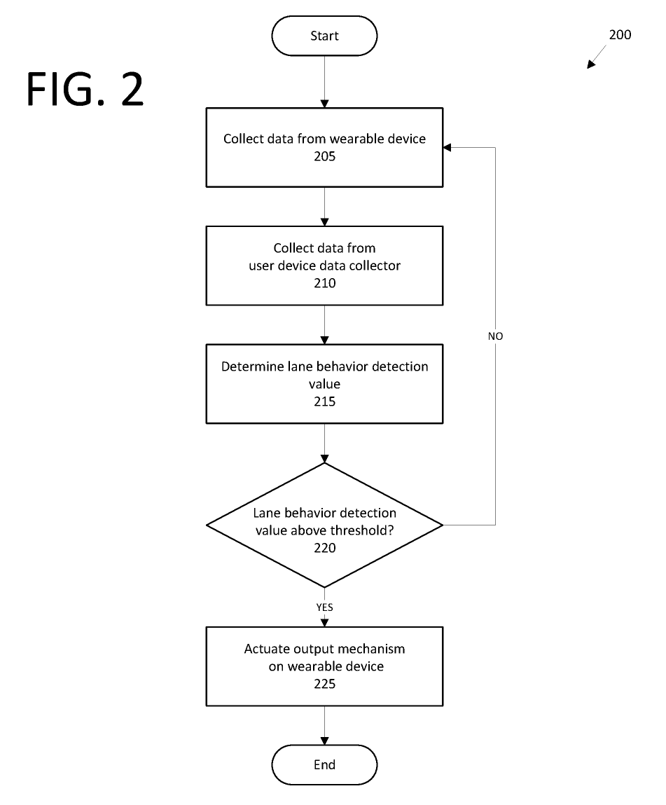

FIG. 2 illustrates an example process 200 employing the wearable device 140 and the data collector 145. The process 200 begins in a block 205 where the processor 155 executes programming to collect data from the data collector 145. The process 200 may alternatively be executed in the wearable device 140 or the vehicle computer 105. In particular, the data may include wrist and/or arm movement collected by the data collector 145, e.g, an accelerometer. Characteristic movement of the wrist and/or arm of the occupant may indicate steering movement and subsequent movement of the vehicle 101 within a lane. Erratic lane behavior may be caused from and/or detected according to increased variability of the wrist and arm movement on the vehicle steering wheel, e.g., using device 140 accelerometer data as described below. The data sent to the processor 155 may be raw data, i.e values that have not been transformed, modified, or otherwise processed, sent from the data collector 145, and/or data processed by the wearable device 140. Thus, the wearable device 140 and the user device 150 may constitute a distributed processing system.

Next, in a block 210, the processor 155 is pro ed to collect data from the data collector 160 on the user device 150. For example, the processor 155 can be programmed to collect location data, e.g. global position system (GPS) data, of the user device 150 to determine a change in lateral movement of the vehicle 101. In another example, a motion detector data collector 145 could be used to determine lateral movement the wearable device 140 i.e., a component of movement of the device 140 that is substantially perpendicular to a longitudinal axis and/or direction of travel of the vehicle 101. Changes in the lateral position of the user device 150 may indicate movement of the vehicle 101 in a lane, and may be used in generating a lane behavior warning. Furthermore, the user device 150 may collect data 115 from the data collectors 110 in the vehicle 101.

Next, in a block 215, the processor 155 is programmed to determine a Lane Behavior Detection (LBD) value. The LBD value characterizes the occupant's lane behavior based on the wrist and/or arm movement of the wearable device 140 and the change in lateral position movement of the user device 150. The LBD value may be determined by recursive computation of the mean and standard deviation of the accelerometer data from the wearable device 140. For example, the LBD value based on the acceleration data may be determined based on the following equations:

Δαₖ=αₖ−α̅ₖ (1)

α̅ₖ₊₁=(1−α)α̅ₖ+α·αₖ (2)

VAR_{LBD,k+1}=(1−α)(VAR_{LBD,k}+α·Δαₖ² (3)

LBDₖ₊₁=\sqrt{VAR_{LBD,k+1}} (4)

where αₖ is the current accelerometer value from the wearable device 140, α is a tunable gain between 0 and 1 that may be predetermined and stored in the data store 156 and/or the server 125, k is an index that starts at 1 and signifies the index of the current value, α̅ₖ is the mean of the accelerometer values collected between 1 and k, VAR_{LBD,k} is the variance of the accelerometer value, and LBDₖ is the LBD value. The LBD value LBDₖ may be normalized to a value between 0 and 1.

The LBD value may be determined for respective periods of time, and may be aggregated and normalized into a value between 0 and 1 to obtain a personalized driver lane behavior character stored in the data store 156 and/or the server 125. A higher LBD value (e.g. greater than 0.8 and/or 2-3 standard deviations above a mean LBD value) may indicate erratic lane behavior with a larger amount of lateral movement within the lane, e.g., a novice driver or a driver applying techniques for vehicles with loose steering. A lower LBD value (e.g. less than 0.3) may indicate steady driving. Similarly, a LBD value may be determined from recursive computation of the mean and standard deviation of the change in lateral position of the vehicle 101 as determined by the user device 150. For example, the LBD value based on the change in lateral data may be determined based on the following equations:

Δlₖ=lₖ−l̅ₖ (5)

l̅ₖ₊₁=(1−α)l̅ₖ+α·lₖ (6)

VAR_{LBD,k+1}=(1−α)VAR_{LBD,k}+α·Δlₖ²) (7)

LBDₖ₊₁=\sqrt{VAR_{LBD,k+1}} (8)

where lₖ is the current lateral position value, α is the tunable gain as described above, l̅ₖ is the mean of the change in lateral position value from 1 to k, VAR_{LBD,k} is the variance of the lateral position value, and LBDₖ is determined as in Equation 4 by taking the square root of the variance VAR_{LBD,k}. The LBD value LBDₖ may be normalized to a value between 0 and 1.

The LBD values computed may be used separately or comparatively tracked to, e.g., provide an estimate of the certainty of the most current LBD value. The processor 155 may be programmed to determine a mean LBD value, being the arithmetic average of a set of LBD values over a specified period of time. Thus, the wearable device 140 and the user device 150 may be used in any vehicle 101, even a vehicle 101 that does not have a conventional lane negotiation alert system. The processor 155 may use data 115 from the wearable device 140, the user device data collectors 160, and/or the vehicle 101 to determine the LBD value.

Next, in a block 220, the processor 155 is programmed to determine whether the LBD value is above a predetermined threshold. The threshold may be determined from a normalized standard deviation of the accelerometer data 115 from the wearable device 140, e.g., 2-3 standard deviations from a mean acceleration value of the wearable device 140, or may be stored on the server 125 and collected by the user device 150. The threshold may be adjusted to account for the specific vehicle occupant, or may be set at a specific value for a specific vehicle 101. The processor 155 may be programmed to use the current LBD value or the mean LBD value. If the LBD value is below the threshold, the process 200 returns to the block 205 to collect more data. Otherwise, the process 200 continues in a block 225.

In the block 225, the processor 155 provides an instruction to the wearable device 140 to actuate one or more output mechanisms. The output mechanisms may include haptic output, e.g. a vibration, audio output, and/or visual output, e.g. flashing lights, flashing colors, etc. The one or more output mechanism may be selected according to the occupant. For example, an occupant who is hard of hearing may have a stronger vibration output, while another occupant may prefer a visual output. Thus, the driver of the vehicle 101 in the context of the present system 100 can correct their driving behavior, e.g., take evasive and/or avoidance action earlier. The output mechanisms may be actuated before, after, and/or in conjunction with a lane departure warning produced by the computing device 105. The process 200 then ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

Computing devices 105 generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device 105 is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 200, one or more of the steps could be omitted, or the steps could be executed in a different order than shown in FIG. 2. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1.-20. (canceled)

21. A system, comprising a computer including a processor and a memory, the memory storing instructions executable by the computer to:
determine a lane behavior detection value that is a measure of wrist movement of a vehicle occupant; and
provide an output wearable device when the lane behavior detection value exceeds a threshold.

22. The system of claim 21, wherein the instructions include instructions to determine the lane behavior detection value based at least in part on the arm movement of the vehicle occupant.

23. The system of claim 21, wherein the output is a haptic output.

24. The system of claim 21, wherein the instructions include instructions to determine the lane behavior detection value in a handheld user device.

25. The system of claim 24, wherein the instructions include instructions to determine the lane behavior detection value in the handheld user device and the wearable device.

26. The system of claim 21, wherein the instructions include instructions to determine the lane behavior detection value based at least in part on location data of a handheld user device.

27. The system of claim 21, further comprising at least one of an accelerometer, a gyroscope, and a global position system.

28. The system of claim 21, wherein the wearable device includes an accelerometer.

29. The system of claim 21, wherein the instructions include instructions to determine a mean lane behavior detection value from a set of previous lane behavior detection values.

30. The system of claim 29, wherein the instructions include instructions to actuate the mechanism when the mean lane behavior detection value exceeds the threshold.

31. A method, comprising:
determining a lane behavior detection value that is a measure of wrist movement of a vehicle occupant; and
providing an output in a wearable device when the lane behavior detection value exceeds a threshold.

32. The method of claim 31, further comprising determining the lane behavior detection value based at least in part on the arm movement of the vehicle occupant.

33. The method of claim 31, wherein the output is a haptic output.

34. The method of claim 31, further comprising determining the lane behavior detection value based at least in part on location data of a handheld user device.

35. The method of claim 31, further comprising determining a mean lane behavior detection value from a set of previous lane behavior detection values.

36. A system, comprising:
a wearable device;
means for determining a lane behavior detection value that is a measure of wrist movement of a vehicle occupant; and
means for providing an output in the wearable device when the lane behavior detection value exceeds a threshold.

37. The system of claim 36, further comprising means for determining the lane behavior detection value based at least in part on the arm movement of the vehicle occupant.

38. The system of claim 36, wherein the output is a haptic output.

39. The system of claim 36, further comprising means for determining the lane behavior detection value based at least in part on location data of a handheld user device.

40. The system of claim 36, further comprising means for determining a mean lane behavior detection value from a set of previous lane behavior detection values.
